(19) United States
(12) Patent Application Publication
(10) Pub. No.: US 2025/0279930 A1
(43) Pub. Date: Sep. 4, 2025

(54) MULTI-PROTOCOL OPEN RADIO ACCESS NETWORK SYSTEM

(71) Applicants: INVENTEC (PUDONG) TECHNOLOGY CORPORATION, Shanghai (CN); INVENTEC CORPORATION, Taipei City (TW)

(72) Inventor: Yi-Chieh HUANG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 18/742,748

(22) Filed: Jun. 13, 2024

(30) Foreign Application Priority Data
Mar. 4, 2024 (CN) 202410244943.2

(51) Int. Cl. H04L 41/0806; H04W 24/02; H04W 88/12

(52) U.S. Cl. CPC H04L 41/0806; H04W 24/02; H04W 88/12

(57) ABSTRACT

A multi-protocol open radio access network (O-RAN) system includes a service management and orchestration (SMO) apparatus and a near-real time RAN intelligent controller (near-RT RIC). The SMO apparatus includes a non-real time RAN intelligent controller (non-RT RIC), the non-RT RIC includes a first multi-protocol interface configured to receive first packets corresponding to different communication protocols and format the first packets to generate first formatted data. The near-RT RIC is connected to the SMO apparatus and includes a second multi-protocol interface configured to receive second packets corresponding to different communication protocols and format the second packets to generate second formatted data.

### CROSS-REFERENCE TO RELATED APPLICATIONS

This non-provisional application claims priority under 35 U.S.C. § 119 (a) on Patent Application No(s). 202410244943.2 filed in China on Mar. 4, 2024, the entire contents of which are hereby incorporated by reference.

### BACKGROUND

### 1. Technical Field

This disclosure relates to a multi-protocol open radio access network system.

### 2. Related Art

Implementing a 5G private network with a 5G open architecture and applying the 5G private network in the context of smart factories is gradually becoming a mainstream consensus. The open architecture of 5G mainly follows the interface standards defined by the Open Radio Access Network (O-RAN) organization, and base station management and optimization are carried out using the Service Management and Orchestration (SMO) system for 5G services.

However, in the existing architecture of the 5G Open Radio Access Network, the open radio access network can only communicate with 5G devices and cannot integrate and connect with existing devices in the Internet of Things, thus unable to achieve unified supervision.

### SUMMARY

Accordingly, this disclosure provides a multi-protocol open radio access network system.

According to one or more embodiment of this disclosure, a multi-protocol open radio access network (O-RAN) system includes: a service management and orchestration (SMO) apparatus and a near-real time RAN intelligent controller (near-RT RIC). The SMO apparatus includes a non-real time RAN intelligent controller (non-RT RIC), wherein the non-RT RIC includes a first multi-protocol interface configured to receive first packets corresponding to different communication protocols and format the first packets to generate first formatted data. The near-RT RIC is connected to the SMO apparatus and includes a second multi-protocol interface configured to receive second packets corresponding to different communication protocols and format the second packets to generate second formatted data.

In view of the above description, the multi-protocol O-RAN system according to one or more embodiments of the present disclosure, in addition to existing interfaces (for example, A1 interface and O1 interface) of the SMO apparatus, the SMO apparatus may integrate connections with external devices (such as user equipment and IoT device) using other communication protocols. Therefore, in addition to communication equipment under the 5G network architecture, the SMO apparatus may also manage other non-5G communication equipment, and may also integrate device information from the Internet of Things to obtain more comprehensive equipment information and allow for unified supervision of both 5G communication equipment and non-5G communication equipment. Further, the multi-protocol O-RAN system according to one or more embodiments of the present disclosure may directly (not passing through the base station) output data to the Non-RT RIC and the Near-RT RIC, respectively, because the first MPI may be configured to communicate with the first device directly and the second MPI may be configured to communicate with the second device directly. Accordingly, the workload of the base station may be lowered, and the efficiency of transmitting data to the SMO apparatus may be improved.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram illustrating a multi-protocol open radio access network (O-RAN) system according to an embodiment of the present disclosure;

FIG. 2A is a block diagram illustrating a non-real time radio access network (RAN) intelligent controller according to an embodiment of the present disclosure;

FIG. 2B is a block diagram illustrating a near-real time RAN intelligent controller according to an embodiment of the present disclosure;

FIG. 3 is a block diagram illustrating a multi-protocol open radio access network system according to another embodiment of the present disclosure; and

FIG. 4 is a structural diagram illustrating a multi-protocol open radio access network system according to one or more embodiments of the present disclosure.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present invention. The following embodiments further illustrate various aspects of the present invention, but are not meant to limit the scope of the present invention.

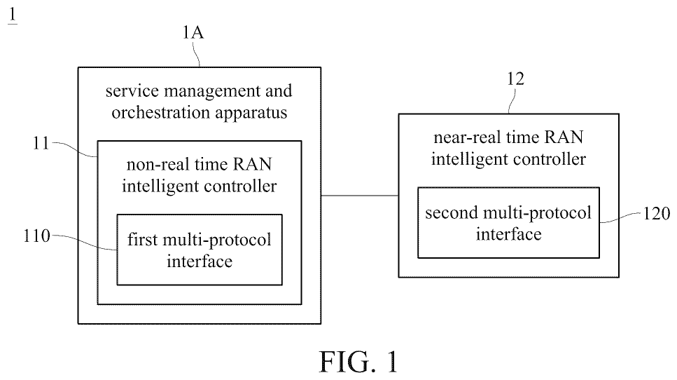

Please refer to FIG. 1, wherein FIG. 1 is a block diagram illustrating a multi-protocol open radio access network (O-RAN) system according to an embodiment of the present disclosure. As shown in FIG. 1, the multi-protocol O-RAN system 1 includes a service management and orchestration (SMO) apparatus 1A and a near-real time radio access network (RAN) intelligent controller (Near-RT RIC) 12. The SMO apparatus 1A includes a non-real time RAN intelligent controller (Non-RT RIC) 11. The SMO apparatus 1A is connected to the Near-RT RIC 12.

Further, the Non-RT RIC 11 includes a first multi-protocol interface (MPI) 110, and the Near-RT RIC 12 includes a second MPI 120. The first MPI 110 is configured to receive a plurality of first packets corresponding to different communication protocols and format the plurality of first packets to generate first formatted data. The second MPI 120 is configured to receive a plurality of second packets corresponding to different communication protocols and format the plurality of second packets to generate second formatted data.

For example, the first MPI 110 may support at least two of Representational State Transfer Application Programming Interface (RESTful), Message Queuing Telemetry Transport (MQTT), Simple Network Management Protocol (SNMP), Websocket, TR069 protocol and Kafka, and the second MPI 120 may support at least two of RESTful, MQTT, SNMP, Websocket, TR069 protocol and Kafka. Accordingly, the first MPI 110 and the second MPI 120 may communicate with a connected terminal device using the communication protocol of the terminal device.

In other words, in the structure of FIG. 1, the first MPI 110 may be configured to connect a first device, the first device may include user equipment and an Internet-of-things (IoT) device, such as an artificial intelligence of things (AIoT) device; and the second MPI 120 may be configured to connect the second device, the second device may include a heterogeneous device, that is, the heterogeneous device connecting local area network with different operating system. Further, when a communication between the first MPI 110 and the first device is interrupted, the first MPI 110 may reconnect the first device. Similarly, when a communication between the second MPI 120 and the second device is interrupted, the second MPI 120 may reconnect the second device.

Through the structure of FIG. 1, in addition to existing interfaces (for example, A1 interface used for communication between the Non-RT RIC and the Near-RT RIC, and O1 interface used for fault, configuration, accounting, performance, security (FCAPS)) of the SMO apparatus, the SMO apparatus may integrate connections with external devices (such as user equipment and IoT device) using other communication protocols. Therefore, in addition to communication equipment under the 5G network architecture, the SMO apparatus may also manage other non-5G communication equipment, and may also integrate device information from the Internet of Things to obtain more comprehensive equipment information and allow unified supervision of both 5G communication equipment and non-5G communication equipment.

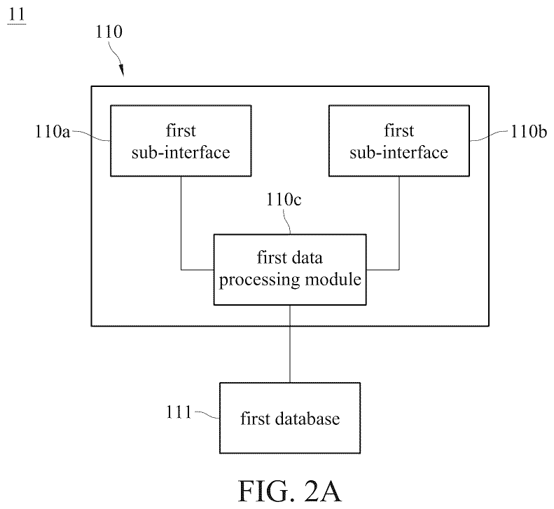

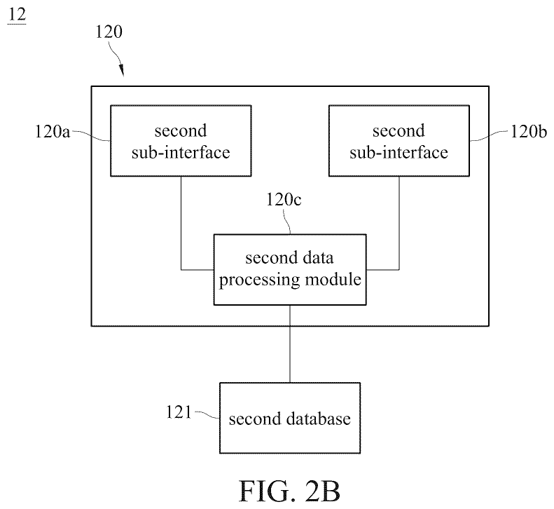

Please refer to FIG. 2A, wherein FIG. 2A is a block diagram illustrating a non-real time RAN intelligent controller according to an embodiment of the present disclosure. As shown in FIG. 2A, the Non-RT RIC 11 includes a plurality of first sub-interfaces 110a and 110b and a first data processing module 110c. The first sub-interfaces 110a and 110b are connected to the first data processing module 110c. The first sub-interface 110a and the first sub-interface 110b support different communication protocols, and may be each implemented with application programming interface (API). Further, the Non-RT RIC 11 may further include a first database 111. The first database 111 is connected to the first data processing module 110c. The first data processing module 110c may be implemented with software application, such as a decoder.

The first sub-interfaces 110a and 110b are configured to receive the first packets, respectively, and the first data processing module 110c is configured to format the first packets to generate the first formatted data. In other words, the first sub-interface 110a is configured to receive the first packet(s) corresponding to a communication protocol, the first sub-interface 110b is configured to receive the first packet(s) corresponding to another communication protocol, and the first data processing module 110c is configured to unify the formats of the first packets corresponding to different communication protocols to generate the first formatted data of the first packet(s) corresponding to the first sub-interface 110a and the first formatted data of the first packet(s) corresponding to the first sub-interface 110b. Further, after generating the first formatted data, the first data processing module 110c may store the first formatted data into the first database 111.

In an embodiment, a user may configure device settings for the user equipment in the first data processing module 110c (for example, providing connection information, authorization information, and protocol types to the first MPI 110). Subsequently, the first data processing module 110c may connect to the user equipment based on the device configuration and obtain device data of the user equipment. The first data processing module 110c may then store the device data in the first database 111 according to routing rules.

Please refer to FIG. 2B, wherein FIG. 2B is a block diagram illustrating a near-real time RAN intelligent controller according to an embodiment of the present disclosure. As shown in FIG. 2B, the Near-RT RIC 12 includes a plurality of second sub-interfaces 120a and 120b and a second data processing module 120c. The second sub-interfaces 120a and 120b are connected to the second data processing module 120c. The second sub-interface 120a and the second sub-interface 120b support different communication protocols, and may be implemented with application programming interface (API). Further, the Near-RT RIC 12 may further include a second database 121. The second database 121 is connected to the second data processing module 120c. The second data processing module 120c may be implemented with software application, such as a decoder.

The second sub-interfaces 120a and 120b are configured to receive the second packets, respectively, and the second data processing module 120c is configured to format the second packets to generate the second formatted data. In other words, the second sub-interface 120a is configured to receive the second packet(s) corresponding to a communication protocol, the second sub-interface 120b is configured to receive the second packet(s) corresponding to another communication protocol, and the second data processing module 120c is configured to unify the formats of the second packets corresponding to different communication protocols to generate the second formatted data of the second packet(s) corresponding to the second sub-interface 120a and the second formatted data of the second packet(s) corresponding to the second sub-interface 120b. Further, after generating the second formatted data, the second data processing module 120c may store the second formatted data into the second database 121.

In FIG. 2A and FIG. 2B, the first sub-interfaces 110a and 110b are at least partially the same as the second sub-interfaces 120a and 120b. That is, at least one of the first sub-interfaces 110a and 110b may be the same as at least one of the second sub-interfaces 120a and 120b. It should be noted that each of FIG. 2A and FIG. 2B shows two sub-interfaces, the first MPI of the Non-RT RIC may include more than two sub-interfaces, the second MPI of the Near-RT RIC may include more than two sub-interfaces, and the number of sub-interfaces of the first MPI may be the same as or different from that of the second MPI. For example, the first sub-interfaces and the second sub-interfaces may respectively include the application interfaces of at least two of RESTful, MQTT, SNMP, Websocket, TR069 protocol and Kafka.

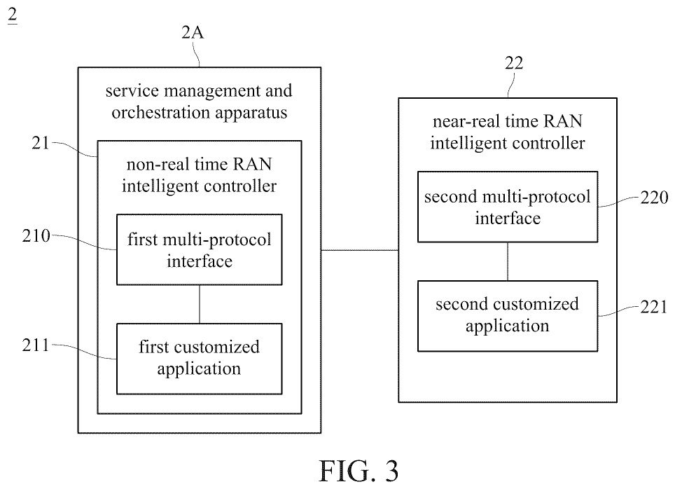

Please refer to FIG. 3, wherein FIG. 3 is a block diagram illustrating a multi-protocol open radio access network system according to another embodiment of the present disclosure. As shown in FIG. 3, the multi-protocol O-RAN system 2 includes a SMO apparatus 2A and a Near-RT RIC 22. The SMO apparatus 2A includes a Non-RT RIC 21. The SMO apparatus 2A is connected to the Near-RT RIC 22.

Further, the Non-RT RIC 21 includes a first MPI 210 and a first customized application 211, and the Near-RT RIC 22 includes a second MPI 220 and a second customized application 221. The implementation of the first MPI 210 may be the same as the first MPI of one or more embodiments described with reference to FIG. 1 and FIG. 2A, and the implementation of the second MPI 220 may be the same as the second MPI of one or more embodiments described with reference to FIG. 1 and FIG. 2B, details of the first MPI 210 and the second MPI 220 are not repeated herein.

The first customized application 211 is, for example, rAPP. The first customized application 211 may be connected to the first MPI 210 to receive the first formatted data. Further, the first customized application 211 may connect to and communicate with the first device described above through the first MPI 210.

The second customized application 221 is, for example, xAPP. The second customized application 221 may be connected to the second MPI 220 to receive the second formatted data. Further, the second customized application 221 may connect to and communicate with the second device described above through the second MPI 220.

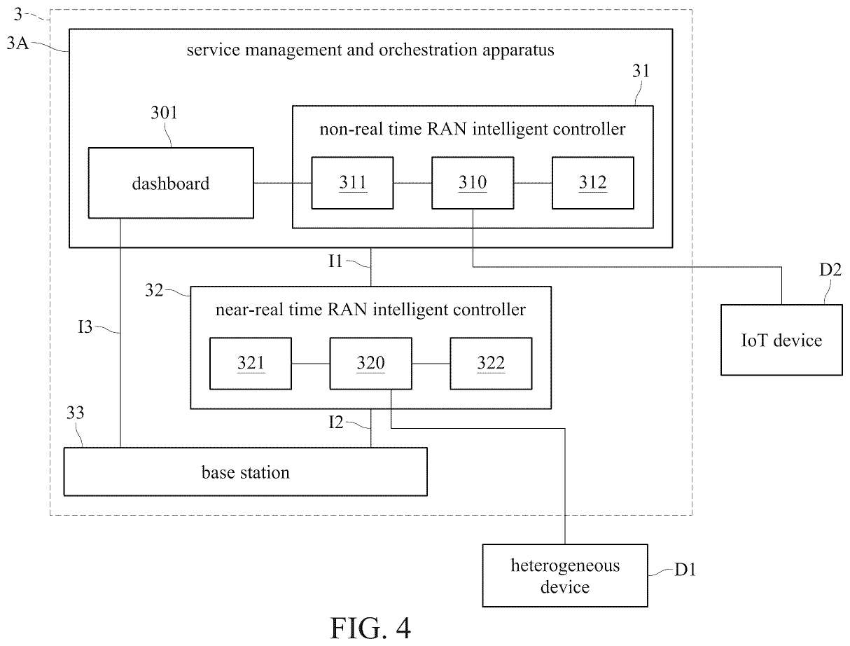

Please refer to FIG. 4, wherein FIG. 4 is a structural diagram illustrating a multi-protocol open radio access network system according to one or more embodiments of the present disclosure. As shown in FIG. 4, the multi-protocol O-RAN system 3 includes a SMO apparatus 3A, a Near-RT RIC 32 and a base station 33. The SMO apparatus 3A includes a Non-RT RIC 31 and a dashboard 301, wherein the Non-RT RIC 31 is connected to the dashboard 301. The SMO apparatus 3A is connected to the Near-RT RIC 32.

The SMO apparatus 3A may be connected to the Near-RT RIC 32 through the first interface I1, the Near-RT RIC 32 may be connected to the base station 33 through the second interface I2, and the SMO apparatus 3A may be connected to the base station 33 through the third interface I3. The first interface I1 may be an interface used for communication between the Non-RT RIC 31 and the Near-RT RIC 32, such as the A1 interface; the second interface 12 may be an interface used for communication between the Near-RT RIC 32 and the base station 33, such as the E1 interface (may also be referred to as E2 node); and the third interface I3 may be a fault, configuration, accounting, performance, security (FCAPS) interface, such as the O1 interface.

The dashboard 301 may be implemented with software application, and may be used to present the operation status of the SMO apparatus 3A, the operation status may include the connection status of the first interface I1, the second interface I2 and the third interface I3, etc.

The base station 33 may be an O-RAN base station, and include gNB, a distributed unit (DU), a central unit (CU), and a radio unit (RU).

The Non-RT RIC 31 includes a first MPI 310, a first database 311 and a first customized application 312, and the Near-RT RIC 32 includes a second MPI 320, a second database 321 and a second customized application 322. The implementation of the first MPI 310 may be the same as the first MPI of one or more embodiments described with reference to FIG. 1 and FIG. 2A, and the implementation of the second MPI 320 may be the same as the second MPI of one or more embodiments described with reference to FIG. 1 and FIG. 2B; the implementation of the first database 311 may be the same as the first database of one or more embodiments described with reference to FIG. 2A, and the implementation of the second database 321 may be the same as the second database of one or more embodiments described with reference to FIG. 2B; the implementations of the first customized application 312 and the second customized application 322 may be the same as the first customized application 211 and the second customized application 221 of one or more embodiments described with reference to FIG. 3, respectively, their details are not repeated herein.

In addition, as described above, the first MPI 310 of the Non-RT RIC 31 may be configured to connect an IoT device D2, meaning the first device described above. The second MPI 320 of the Near-RT RIC 32 may be configured to connect a heterogeneous device D1, meaning the second device described above.

In the embodiment of FIG. 4, the Non-RT RIC 31 may be set in advance to determine whether to transmit the first formatted data to the first database 311 and/or the first customized application 312 according to the setting. Similarly, the Near-RT RIC 32 may be set in advance to determine whether to transmit the second formatted data to the second database 321 and/or the second customized application 322 according to the setting.

In view of the above description, the multi-protocol O-RAN system according to one or more embodiments of the present disclosure, in addition to existing interfaces (for example, A1 interface and O1 interface) of the SMO apparatus, the SMO apparatus may integrate connections with external devices (such as user equipment and IoT device) using other communication protocols. Therefore, in addition to communication equipment under the 5G network architecture, the SMO apparatus may also manage other non-5G communication equipment, and may also integrate device information from the Internet of Things to obtain more comprehensive equipment information and allow for unified supervision of both 5G communication equipment and non-5G communication equipment. Further, because the first MPI may be configured to communicate with the first device directly and the second MPI may be configured to communicate with the second device directly, the multi-protocol O-RAN system according to one or more embodiments of the present disclosure may directly (not passing through the base station) output data to the Non-RT RIC and the Near-RT RIC, respectively. Accordingly, the workload of the base station may be lowered, and the efficiency of transmitting data to the SMO apparatus may be improved.

In an embodiment of the present disclosure, the multi-protocol O-RAN system of the present invention may be applied to 5G private network and system composed of 5G small base stations.

What is claimed is:

1. A multi-protocol open radio access network system, comprising:
a service management and orchestration apparatus comprising a non-real time radio access network (RAN) intelligent controller, wherein the non-real time RAN intelligent controller comprises a first multi-protocol interface, and the first multi-protocol interface is configured to receive a plurality of first packets corresponding to different communication protocols and format the plurality of first packets to generate first formatted data; and
a near-real time RAN intelligent controller connected to the service management and orchestration apparatus, wherein the near-real time RAN intelligent controller comprises a second multi-protocol interface, and the second multi-protocol interface is configured to receive a plurality of second packets corresponding to different communication protocols and format the plurality of second packets to generate second formatted data.

2. The multi-protocol open radio access network system according to claim 1, wherein
the first multi-protocol interface comprises a plurality of first sub-interfaces and a first data processing module, the first data processing module is connected to the plurality of first sub-interfaces, the plurality of first sub-interfaces are configured to receive the plurality of first packets, respectively, and the first data processing module is configured to format the plurality of first packets to generate the first formatted data,
the second multi-protocol interface comprises a plurality of second sub-interfaces and a second data processing module, the second data processing module is connected to the plurality of second sub-interfaces, the plurality of second sub-interfaces are configured to receive the plurality of second packets, respectively, and the second data processing module is configured to format the plurality of second packets to generate the second formatted data.

3. The multi-protocol open radio access network system according to claim 2, wherein the plurality of first sub-interfaces are at least partially the same as the plurality of second sub-interfaces.

4. The multi-protocol open radio access network system according to claim 2, wherein
the non-real time RAN intelligent controller further comprises a first database, the first database is connected to the first data processing module, the first database is configured to store the first formatted data, and
the near-real time RAN intelligent controller further comprises a second database, the second database is connected to the second data processing module, the second database is configured to store the second formatted data.

5. The multi-protocol open radio access network system according to claim 1, wherein the non-real time RAN intelligent controller further comprises a customized application connected to the first multi-protocol interface to receive the first formatted data.

6. The multi-protocol open radio access network system according to claim 1, wherein the near-real time RAN intelligent controller further comprises a customized application connected to the second multi-protocol interface to receive the second formatted data.

7. The multi-protocol open radio access network system according to claim 1, wherein the first multi-protocol interface supports at least two of Representational State Transfer Application Programming Interface, Message Queuing Telemetry Transport, Simple Network Management Protocol, Websocket, TR069 protocol and Kafka, and the second multi-protocol interface supports at least two of Representational State Transfer Application Programming Interface, Message Queuing Telemetry Transport, Simple Network Management Protocol, Websocket, TR069 protocol and Kafka.

8. The multi-protocol open radio access network system according to claim 1, wherein the first multi-protocol interface is further configured to connect an Internet-of-things device.

9. The multi-protocol open radio access network system according to claim 1, wherein the second multi-protocol interface is further configured to connect a heterogeneous device.

10. The multi-protocol open radio access network system according to claim 1, wherein
the first multi-protocol interface is further configured to connect an Internet-of-things device, and reconnect the Internet-of-things device when communication with the Internet-of-things device is interrupted, and
the second multi-protocol interface is further configured to connect a heterogeneous device, and reconnect the heterogeneous device when communication with the heterogeneous device is interrupted.
